(19) United States
(12) Patent Application Publication
(10) Pub. No.: US 2017/0111729 A1
(43) Pub. Date: Apr. 20, 2017

(54) LOUDSPEAKER

(71) Applicant: MUSIC Group IP Ltd., Road Town (VG)

(72) Inventors: Philippe Jean-Baptiste ROBINEAU, Coatbridge Lanarkshire (GB); Ludovico AUSIELLO, Coatbridge Lanarkshire (GB)

(21) Appl. No.: 15/291,986

(22) Filed: Oct. 12, 2016

(30) Foreign Application Priority Data
Oct. 14, 2015 (GB) 1518214.0

(51) Int. Cl. H04R 1/24; H04R 31/00; H04R 1/30

(52) U.S. Cl. CPC H04R 1/24; H04R 1/30; H04R 31/006; H04R 2400/11

(57) ABSTRACT

A coaxial loudspeaker has a first driver producing sound within a first frequency band and a second driver coaxial with the first driver producing sound within a second higher frequency band. The first driver includes a first moveable membrane coupled and moveable relative to a frame to generate sound waves within the first frequency band. The first moveable membrane extends from adjacent a central axis to an outer part above and spaced apart from a rim of the frame, the outer part being resiliently coupled to the rim. The second driver includes a second moveable membrane generating sound waves within the second frequency band. The second moveable membrane is behind or below the first moveable membrane and the resilient coupling is behind the first moveable membrane extending from the rim to the outer part so the surround is not an obstacle to second driver sound waves.

### FIELD OF INVENTION

The present invention relates to a loudspeaker and to parts thereof. The invention has particular relevance to electro-dynamic loudspeakers known as moving coil loudspeakers and more especially those of the type commonly referred to as coaxial.

### BACKGROUND OF INVENTION

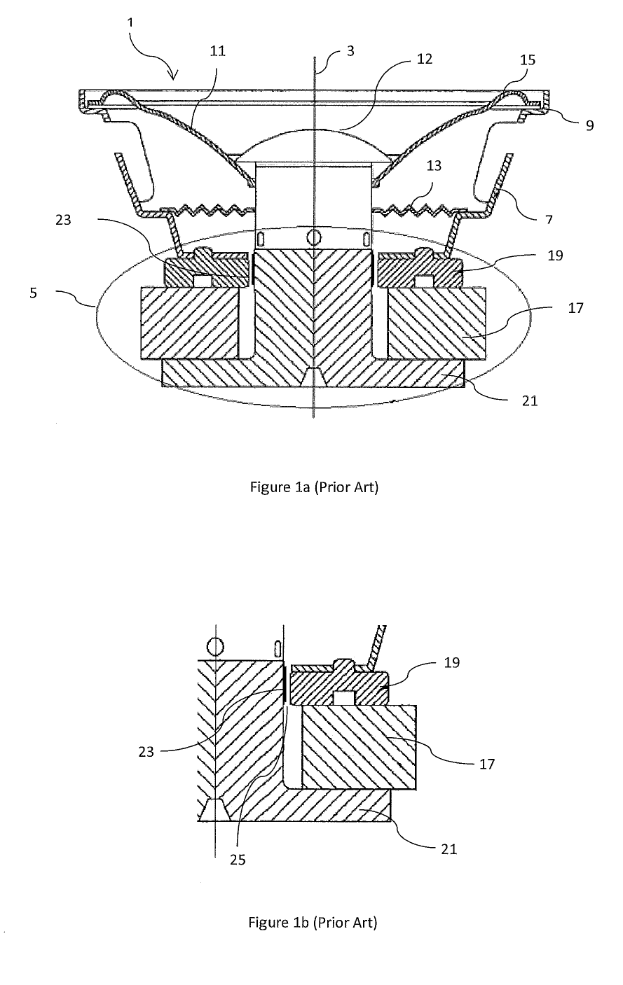

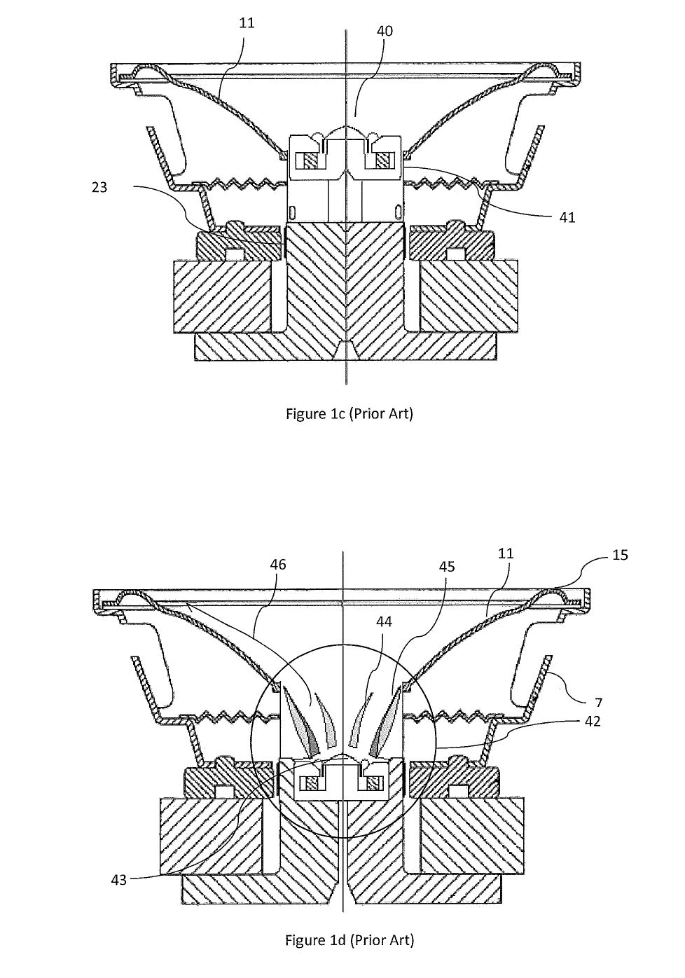

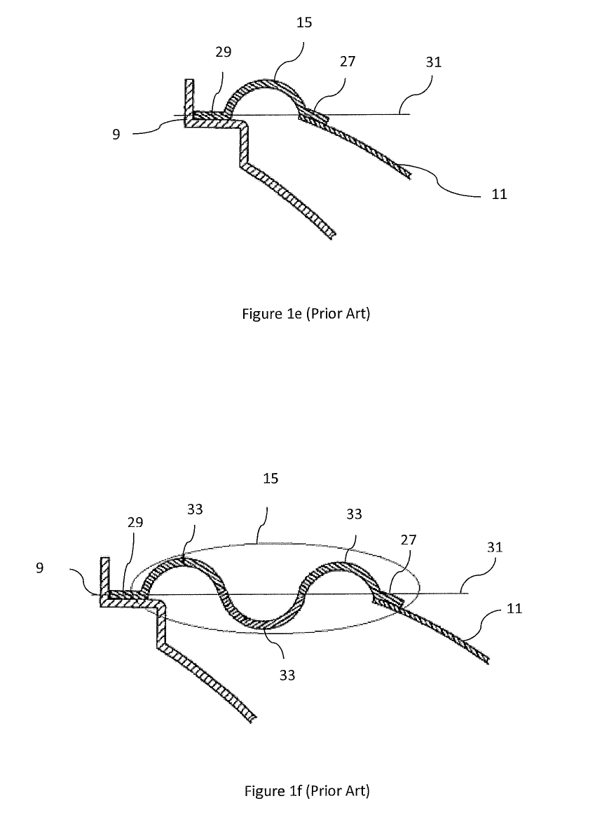

A conventional loudspeaker is an electro-mechanical device (sometimes called a speaker driver) devoted to transduce an electric power signal into air motion, thus producing an acoustic output, i.e. sound. FIG. 1a is a cross-sectional view of a conventional loudspeaker 1 which for the sake of simplicity of description is symmetrical about a central axis 3 of symmetry. The loudspeaker 1 has a solid structure comprising a motor assembly 5 and a frame 7 having an outer rim 9. A membrane 11 is connected to the frame 7 via, at least, two resilient or elastic components: a spider 13 and a surround 15. A part of the membrane 11 is normally used to seal the motor assembly 5 from dust and it is commonly called dust cap 12.

The motor assembly 5 is the active part of the loudspeaker, translating the electric power signal coming from an amplifier into motion. The motor assembly 5 is generally made of several parts including a magnet 17, a top plate 19, a pole piece 21 and a voice coil 23 that is coupled (directly or indirectly) to the membrane 11. FIG. 1b shows in more detail the magnet 17, the top plate 19 and the pole piece 21 which, together, form a magnetic circuit such that a static magnetic field is generated in an air gap 25 between the pole piece 21 and the top plate 19. The voice coil 23 is mounted within this air gap 25. Due to the presence of the static magnetic field, any voltage applied to the voice coil 23 translates into an electro-dynamic force that causes the voice coil 23 to move. As the voice coil is coupled to the moveable membrane 11, this movement of the voice coil causes the membrane 11 to move and to generate sound as a result. The membrane 11 will hereafter be referred to as the moveable membrane 11.

The frame 7 is generally called a basket. The basket 7 is attached to the motor assembly 5 and it supports the moveable membrane 11. The outer edge of the basket 7, called the rim 9, is normally used to host mounting screws which fix the loudspeaker 1 to a baffle or a cabinet (not shown).

The moveable membrane 11 is a rotationally curved surface, obtained by rotating a profile around the speaker's central axis 3. The moveable membrane 11 is often referred to as a cone, because of the straight profile typically used in early loudspeaker designs.

Although to maximize the acoustic output (Sound Pressure Level, or SPL) of a driver a large moveable membrane 11 is desirable, due to several physical constraints, the larger a cone is, the less capable it is of loud (high power) sounds at very high frequencies (greater than about 2000 Hz). This is mainly due to the mass and the consequent inertia of the membrane 11 itself.

This limitation is normally addressed using more than one driver to achieve an extended frequency response without sacrificing the output power. Each of these (two or more) drivers is then designed to reproduce a specific part of the frequency spectrum. Common names for these drivers are woofer (devoted to reproduce frequencies in between 20 Hz and 2000 or 3000 Hz), midrange (mainly used to reproduce frequencies in between 200 Hz and 4000 Hz) and tweeter (solely used to reproduce frequencies higher than about 2000 to 4000 Hz).

All of these electro-dynamic transducers (drivers) share some or all aspects of the general design and working principle (i.e. motor assembly 5) mentioned before in this section, but they also have specific differences which are not relevant to present invention.

A coaxial speaker is a particular example of loudspeaker in which two acoustic transducers (drivers) are mechanically coupled and share the same central acoustic axis 3. The resulting device is as compact as a single woofer, but it is capable of covering the entire audible spectrum.

This layout offers benefits over the use of two separate drivers, the most important of which is that the acoustic centers of the woofer and the tweeter coincide which gives an acoustic output that does not suffer from path differences at different frequencies. Whilst this feature could be too subtle to sense when listening to a single speaker cabinet (mono), once the audio system has two (stereo set) or more (5.1, 7.1, 8.1 surround) speakers, this difference in performance is clearly audible.

Prior art coaxial speakers can be classified into two main types—those that use a dome tweeter and those that use a compression driver. The dome tweeter design is simple and cheap to manufacture but its sound output is of lower quality than that of the compression driver design. FIG. 1c shows a typical design of a dome tweeter coaxial speaker. As shown, a dome tweeter 40 is placed approximatively in the position of the dust cup 12, inside the coupler 41 that couples the moveable membrane 11 to the voice coil 23 of the outer woofer driver. The dome tweeter therefore sits in front of the moveable membrane 11 of the woofer driver.

If a higher acoustic output is desired, then the commonly accepted solution is to use a compression driver rather than a dome tweeter. With the compression driver, the high frequency driver sits behind or below the moveable membrane 11 of the woofer driver and the membrane 11 helps to guide and control delivery of the high frequency sound. FIG. 1d depicts an example of such a compression driver coaxial speaker. The compression driver 42 has its motor assembly, plus several other parts like the compression driver membrane 43, the phase plug 44 and the horn 45. Usual components like the woofer membrane 11 or surround 15 are always present. The purpose of the compression driver 42 is to impose a specific acoustic load on the moveable membrane 43, while the horn 45 and the phase plug 44 re-align the acoustic wave front produced by the movement of the moveable membrane 43 and direct it in a predictable way towards the listener. This solution provides a much higher efficiency and a higher sound pressure level at high frequencies, but it is more complicated and costly to manufacture.

The inventors have found that the compression driver coaxial loudspeaker is susceptible to distortions particularly within the high frequency range of the generated acoustic signals; and they aim to modify the design of the loudspeaker to reduce such distortions.

The invention lies in the recognition by the inventors that to keep distortions to a minimum, the profile of the woofer membrane 11 should follow the profile of the horn 45 and should not present any obstacle protruding inside the portion of space in front of the moveable membrane 11. In particular, the inventors have realized that the conventional design of surround 15 presents such an obstacle in the propagation path (illustrated by the arrow 46 in FIG. 1d) taken by high frequencies generated by the compression driver 42; and that therefore, a new surround design is needed to reduce this distortion.

According to one aspect the present invention provides a coaxial loudspeaker comprising: a first driver for producing sound within a first frequency band; a second driver mounted coaxially with the first driver for producing sound within a second frequency band that is different from the first frequency band; and a frame; wherein the first driver comprises a first moveable membrane coupled to the frame and arranged to move relative to the frame to generate sound waves within said first frequency band in response to input drive signals, the first moveable membrane extending from an inner part adjacent a central axis of the loudspeaker to an outer part located above and spaced apart from a rim of the frame, the outer part of the first moveable membrane being coupled to the rim of the frame by a resilient surround; wherein the second driver comprises a second moveable membrane arranged to move to generate sound waves within said second frequency band in response to input drive signals, wherein the second driver is supported by the first driver such that the second moveable membrane is located below the first moveable membrane; and wherein the resilient surround sits behind the first moveable membrane extending from the rim of the frame to the outer part of the first moveable membrane such that the surround does not present an obstacle to sound waves generated by the second driver.

Typically, the second driver comprises a horn to guide the sound waves generated by the second driver towards a space in front of the first moveable membrane, and wherein the profile of the horn matches a profile of the first moveable membrane.

The resilient surround may extend from a first edge thereof that is fixed to the rim of the frame to a second edge thereof that is fixed to the outer part of the first moveable membrane. The resilient surround normally comprises one or more rolls that extend between the rim of the frame and the outer part of the first moveable membrane. The resilient surround may extend in a direction that is inclined outwardly away from the central axis from the rim of the frame to the outer part of the first moveable membrane or it may extend in a direction that is substantially parallel to the central axis of the loudspeaker.

The resilient surround may further comprise one or more air permeable walls that extend between the rim of the frame and the outer part of the first moveable membrane.

The first driver typically further comprises a motor assembly that is coupled to the frame and to the first moveable membrane such that in response to said input drive signals, the motor assembly causes the first moveable membrane to move relative to said frame.

The first moveable membrane and/or the second moveable membrane may have a circular, elliptical or oval shaped outer part.

The first driver may be arranged to generate sound waves having frequencies within a frequency range below 3000 Hz and the second driver may be arranged to generate sound waves having frequencies within a frequency range above 2000 Hz. Thus the first driver may be a woofer driver and the second driver may be a tweeter driver.

The surround may have an annular shape formed about the central axis of the loudspeaker and comprises a wall that extends in a direction that is substantially parallel with the central axis or that extends in an outward direction extending away from the central axis.

The invention also provides a method of making a coaxial loudspeaker comprising: providing a first driver for producing sound within a first frequency band; providing a second driver for producing sound within a second frequency band that includes frequencies that are higher than said first frequency band; providing a frame; coupling a first moveable membrane of the first driver to the frame so that the first moveable membrane can move relative to the frame to generate sound waves within said first frequency band in response to input drive signals; arranging the first moveable membrane to extend from an inner part adjacent a central axis of the loudspeaker to an outer part located above and spaced apart from a rim of the frame; mounting the second driver on the first driver so that the second driver is coaxial with the first driver and so that a second moveable membrane of the second driver is behind the first moveable membrane of the first driver; and coupling the outer part of the first moveable membrane to the rim of the frame by a resilient surround so that the resilient surround sits behind the first moveable membrane and does not present an obstacle to sound waves generated by the second driver.

These and other aspects of the invention will become apparent from the following detailed description of exemplary embodiments which are described with reference to the accompanying drawings in which:

FIG. 1a is a cross-sectional view of a conventional loudspeaker design;

FIG. 1b shows in more detail the structure of the magnet system which provides the electro-mechanical transducing force for the loudspeaker shown in FIG. 1a;

FIG. 1c is a cross-sectional view of a coaxial loudspeaker that has a central dome tweeter;

FIG. 1d is a cross-sectional view of a coaxial loudspeaker that has a central compression driver;

FIG. 1e is an enlarged cross-sectional view showing the detail of the surround forming part of the coaxial loudspeaker shown in FIG. 1d;

FIG. 1f is an enlarged cross-sectional view showing the detail of an alternative surround;

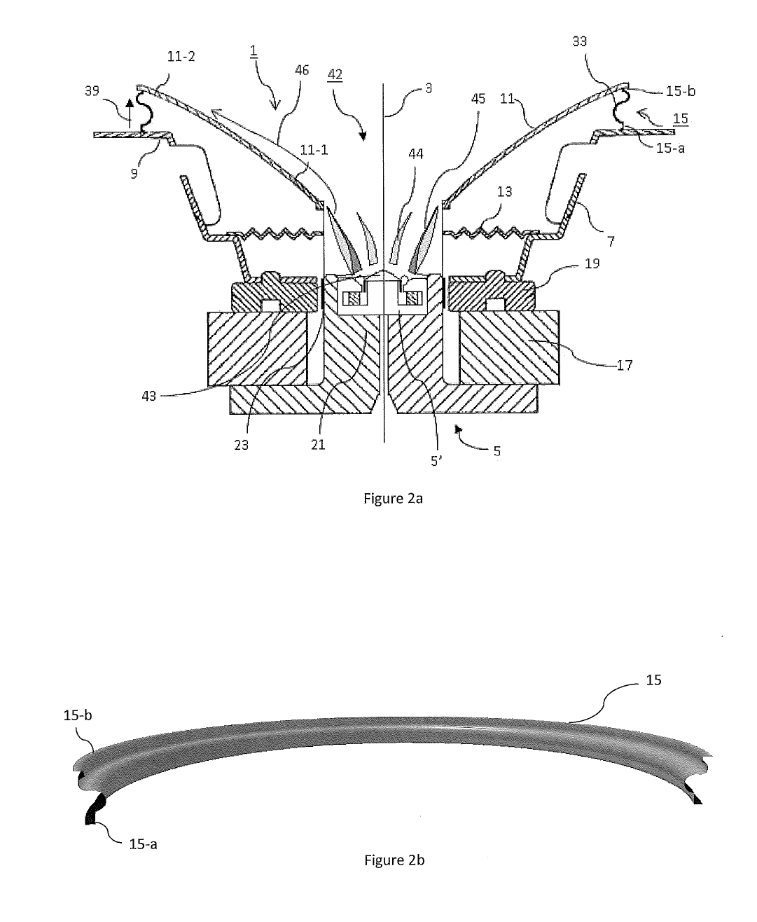

FIG. 2a is a cross-sectional view of a coaxial loudspeaker having a central compression driver and a surround provided under the moveable membrane;

FIG. 2b is a three dimensional cross-sectional view of the surround forming part of the loudspeaker shown in FIG. 2a;

FIG. 3 is a cross-sectional view of a coaxial loudspeaker having a central compression driver and a surround located under the moveable membrane and in which the surround in inclined relative to the central axis of the loudspeaker;

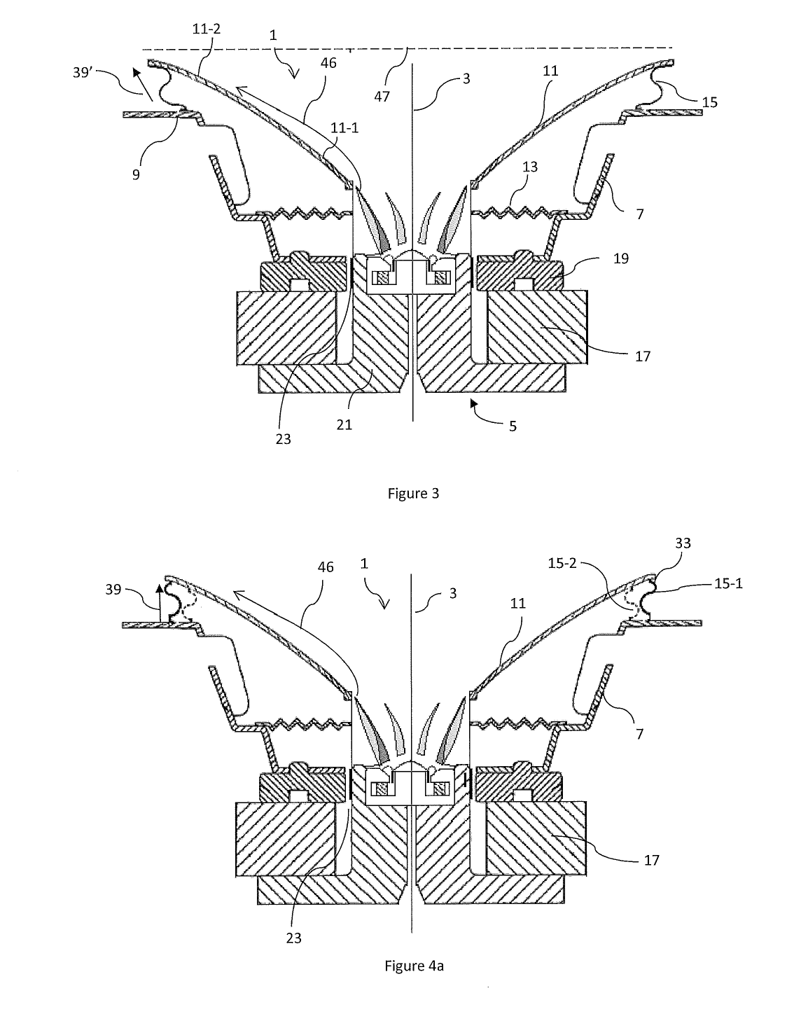

FIG. 4a is a cross-sectional view of a coaxial loudspeaker having a central compression driver and a surround having two substantially parallel walls located under the moveable membrane;

FIG. 4b is a detailed view of an outer edge of the loudspeaker shown in FIG. 4a and illustrating the way in which the loudspeaker may be attached to a wall or baffle; and

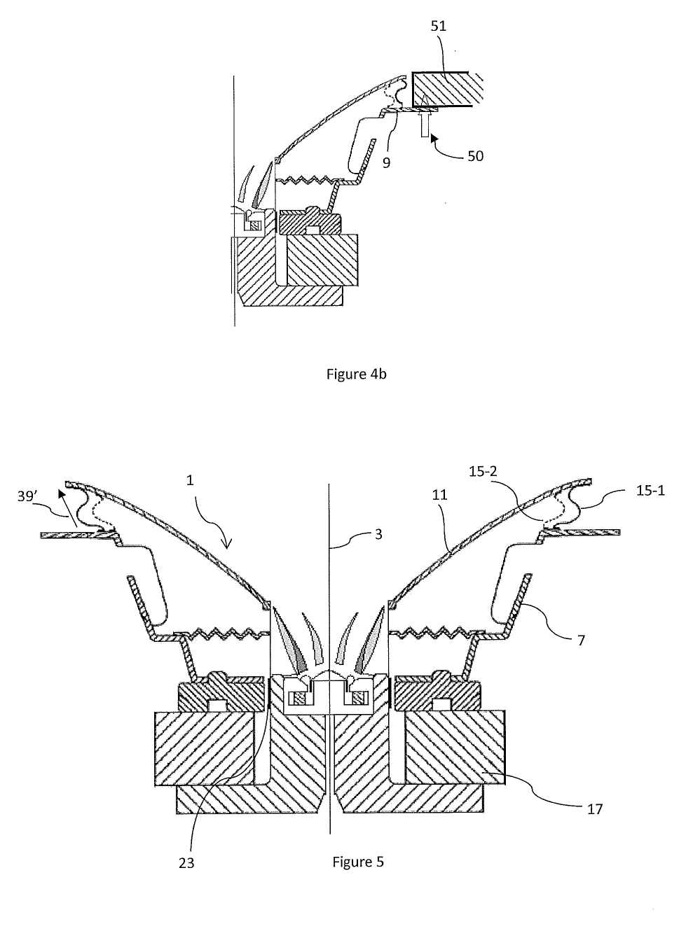

FIG. 5 is a cross-sectional view of a coaxial loudspeaker having a central compression driver and a surround having two substantially parallel and inclined walls located under the moveable membrane.

### OVERVIEW

As will become clear from the loudspeaker designs described below, the surround 15 of the coaxial loudspeaker 1 has been redesigned so that it does not present an obstacle in the high frequency propagation path 46. Before describing the invention, it is instructive to consider the design of the moveable membrane 11 and of the surround 15 in the loudspeaker shown in FIG. 1d.

Referring to FIG. 1d, once the loudspeaker is placed (fixed) in position, the moveable membrane 11 can be considered to divide the space in which it sits into two separated portions: an inner portion in which the basket 7 sits, and an outer portion extending out away from the loudspeaker 1. These portions are separated because the moveable membrane 11 and the surround 15 are formed of a material that is impermeable to air (otherwise movement of the membrane will not create any pressure waves). Thus the membrane 11 can be considered to have an internal surface facing the basket 7 and an external surface facing the outside of the loudspeaker 1.

FIG. 1e shows in more detail the structure of the surround 15 used in the loudspeaker 1 shown in FIG. 1d. As shown, the surround 15 is attached in two locations: the first 27 is at the outer edge of the moveable membrane 11 and the second 29 is at the basket rim 9. As shown, the surround 15 sits in a plane 31 which is perpendicular to the loudspeaker's central axis 3. This plane is commonly the front plane of an enclosure housing the loudspeaker, or the plane of a baffle with which the loudspeaker is flush.

As shown in FIG. 1f, the surround 15 may comprise one or more annular portions, often referred to as rolls 33 instead of just one roll as shown in FIG. 1e. The number and radius of the rolls 33 of a standard surround 15 is directly linked to the maximum excursion of the moveable membrane 11 (i.e. using a large number of small rolls 33 or a single roll 33 with a large radius allows for more movement in the moveable membrane 11). A large maximum displacement is desirable, because it impacts directly on the maximum acoustic output (SPL) of the loudspeaker 1.

In both cases, the surround 15 creates a discontinuity in the smooth profile of the moveable membrane 11 that affects the high frequency acoustic propagation path 46. With the large single roll, the surround's profile is substantially protruding inside the volume in front of the moveable membrane 11 profile, thus contributing to additional reflections of the high frequency acoustic wave. The surround having a large number of smaller rolls will offer a smaller obstacle to the high frequency acoustic propagation path 46, but it extends over a larger portion of the cone flare which will be flexing and bending while the membrane 11 is moving, thus contributing to greater diffraction type distortions.

### First Embodiment

FIG. 2a is a cross-sectional view of a coaxial loudspeaker 1 having a central compression driver 42 embodying the present invention. The loudspeaker 1 has a solid structure comprising a motor assembly 5 and a frame 7 having an outer rim 9. A moveable membrane 11 is coupled to the frame 7 via at least two resilient or elastic components: a spider 13 and a surround 15.

As discussed above, the motor assembly 5 is the active part of the main woofer (lower frequency) driver of the loudspeaker 1, translating an electric power signal coming from an amplifier (not shown) into motion of the moveable membrane 11. The motor assembly 5 has several parts including a magnet 17, a top plate 19, a pole piece 21 and a voice coil 23 that is coupled (directly or indirectly) to the moveable membrane 11. The magnet 17, the top plate 19 and the pole piece 21 form a magnetic circuit such that a static magnetic field is generated in the air gap 25 between the pole piece 21 and the top plate 19. The voice coil 23 is mounted within this air gap 25. Due to the presence of the static magnetic field, any applied voltage to the voice coil 23 translates into an electro-dynamic force that causes the voice coil 23 to move. This causes the membrane 11 to move and generate sound as a result.

The frame 7 (or basket) is attached to the motor assembly 5 and it supports the moveable membrane 11. The moveable membrane 11 is typically a rotationally curved surface, obtained by rotating a profile (in this embodiment a curved profile) around the speaker's central axis 3, which in this embodiment is also an axis of symmetry.

As shown in FIG. 2a, the compression driver 42 (higher frequency driver) is supported by the pole piece 21 of the main woofer driver, such that a moveable membrane 43 of the compression driver 42 sits behind or below (relative to the front of the loudspeaker) the moveable membrane 11 of the woofer driver and the membrane 11 helps to guide and control delivery of the high frequency sound. The compression driver 42 also has a motor assembly 5′, plus the phase plug 44 and the horn 45. The purpose of the compression driver 42 is to impose a specific acoustic load on the moveable membrane 43, while the horn 45 and the phase plug 44 re-align the acoustic wave front produced by the movement of the moveable membrane 43 and direct it in a predictable way towards the listener. The profile of the horn 45 is arranged to match the profile of the woofer's moveable membrane 11 in order to minimize acoustic distortions at the junction between the two.

As shown in FIG. 2a, in this embodiment, the moveable membrane 11 curves outwardly from an inner part 11-1 located adjacent the loudspeaker's central axis 3 to an outer part (or edge) 11-2 adjacent the outer rim 9 of the frame 7. In this embodiment, the moveable membrane 11 has a radial extent (measured from the central axis 3) that is substantially the same as the corresponding radial extent of the frame 7 and it curves such that the outer part 11-2 is above and separated from the rim 9. As shown, the surround 15 (which is generally annular in shape) has a single wall that is fixed at a lower edge 15-a thereof to the rim 9 of the frame 7 and at an upper edge 15-b thereof to the outer part 11-2 of the moveable membrane 11. Thus the single wall of the surround 15 extends (in height) in a direction represented by the arrow 39 that is substantially parallel to the central axis 3 of the loudspeaker 1.

FIG. 2b is a three dimensional cross-sectional view of the surround 15—showing the annular shape of the surround 15.

The surround 15 is formed of a resilient or elastic material, such as rubber (natural or synthetic), vulcanized canvas, coated paper, silicon (for nano-speaker) or foam and has a number of rolls 33 (in this case two rolls) connected together in series between the rim 9 and the outer part 11-2 of the moveable membrane 11 to aid in the resilience of the surround 15.

The moveable membranes 11 and 43 and the surround 15 are all made of materials that are substantially impermeable to air to allow for the efficient generation of sound (pressure) waves as the moveable membranes 11, 43 move. In many speaker designs, the speaker housing (not shown) is designed to separate the inner volume of the loudspeaker 1 from the external volume of air in front of the loudspeaker. In this way, pressure waves generated in front of the loudspeaker 1 do not mix and cancel with the inverse pressure waves generated on the inside of the loudspeaker housing.

The design of the coaxial loudspeaker 1 of this embodiment has the advantage that the surround 15 does not present any obstacle to the high frequencies sound waves (generated by the compression driver) that travel along the high frequency path 46—which helps to minimize sound distortions of the loudspeaker.

### Second Embodiment

FIG. 3 is a cross-sectional view of a coaxial loudspeaker 1 according to a second embodiment of the present invention, in which the surround 15 extends from the rim 9 to the outer part 11-2 of the moveable membrane 11 in a direction represented by arrow 39′ that is inclined at an acute angle relative to the loudspeaker's central axis 3 and to the front plane 47 of the loudspeaker 1. Typically, the surround is inclined relative to the central axis 3 at an angle of between 5 and 45 degrees. This design of loudspeaker 1 has a beneficial effect to the acoustic response of the speaker 1. This is due to a progressive decoupling of the axial movement of the moveable membrane 11 with respect to the direction of the elastic force intrinsically present within the surround 15. As with the embodiment shown in FIG. 2, as the rolls 33 of the surround are located underneath the moveable membrane 11, the surround 15 does not present any obstacle to high frequency sounds travelling along the high frequency propagation path 46.

### Modifications and Alternatives

Two embodiments of the invention have been described above. As those skilled in the art will appreciate, a number of modifications and alternatives can be made to the above embodiments whilst still benefiting from the inventions embodied therein. By way of illustration some of these alternatives and modifications will now be described.

In the embodiments described above, the elastic surround 15 was formed from a single wall of material that is impermeable to air. As those skilled in the art will appreciate, the surround 15 may have multiple walls (two or more), provided that only one of those walls is impermeable to air. FIG. 4a illustrates an alternative loudspeaker design based on the embodiment shown in FIG. 2a, in which the surround 15 has two walls 15-1 and 15-2 that both extend in the direction represented by arrow 39 which is substantially parallel to the loudspeaker's central axis 3. In this embodiment, the inner wall 15-2 is made of a material that is permeable to air (which is represented in the figure by the dashed outline of the inner wall 15-2) whilst the outer wall 15-1 is made of a material that is impermeable to air. As shown in FIG. 4a, the rolls 33 of the two walls of the surround 15 may not be identical, showing different cross-sections and profiles. By making the inner wall 15-2 of the surround permeable to air, air located in the space between the two walls is not trapped and can freely move as the surround 15 deforms to accommodate movement of the moveable membrane 11. Of course, instead of the inner wall 15-2 being permeable to air and the outer wall 15-1 being impermeable to air, the opposite arrangement is possible—with the inner wall 15-2 being impermeable to air and the outer wall 15-1 being permeable to air. As before, the rolls 33 of the surround 15 are located underneath the moveable membrane, and so the surround 15 does not present any obstacle to high frequency sounds travelling along the high frequency propagation path 46.

FIG. 4b illustrates (by way of the arrow 50) the way in which the loudspeaker 1 may be attached to a wall or baffle 51, such that the front surface of the loudspeaker 1 sits flush with the front surface of the wall or baffle 51. As shown, the rim 9 extends beyond the point where the surround 15 connects to the rim, to provide a fixing point for fixing the loudspeaker to the wall or baffle 51.

FIG. 5a, shows a modification to the embodiment shown in FIG. 4a in which a modified surround 15 is used having two walls 15-1 and 15-2, that are inclined relative to the central axis 3. Again, either of the inner wall 15-2 or the outer wall 15-1 may be made of a material that is permeable to air (with the other one being impermeable to air) so that air can flow between the air chamber formed between the two walls and the inner volume of the loudspeaker.

The above described embodiments have used coaxial loudspeakers having a generally circular shape. As those skilled in the art will appreciate, the present invention is applicable to a number of different shapes and designs of coaxial loudspeakers. For example, the present invention is applicable to all possible coaxial loudspeaker shapes, including but not limited to circular, elliptical, and oval shaped coaxial loudspeakers.

The invention can be used with other designs of coaxial loudspeaker, including those described in GB 2502189.

As described above, the moveable membrane 11 is typically a rotationally curved surface, obtained by rotating a profile around the loudspeaker's central axis 3. Depending on the profile curve, the surface of the moveable membrane 11 could be shaped in a number of different ways, offering different mechanical and acoustic properties.

Whilst the coaxial loudspeaker may be sealed into an enclosure or fitted flush with a baffle, it is also possible to have enclosures that are intentionally not sealed. They may have a vent port or employ a horn or a transmission line to enhance some acoustic properties. It will be clear to one of ordinary skill in the art that the present invention could be used in all these enclosure types and other types of speakers such as inverse speakers and the like.

1. A coaxial loudspeaker comprising:
a first driver for producing sound within a first frequency band;
a second driver mounted coaxially with the first driver for producing sound within a second frequency band that includes frequencies that are higher than said first frequency band; and
a frame;
wherein the first driver comprises a first moveable membrane coupled to the frame and arranged to move relative to the frame to generate sound waves within said first frequency band in response to input drive signals, the first moveable membrane extending from an inner part adjacent a central axis of the loudspeaker to an outer part located above and spaced apart from a rim of the frame, the outer part of the first moveable membrane being coupled to the rim of the frame by a resilient surround;
wherein the second driver comprises a second moveable membrane arranged to move to generate sound waves within said second frequency band in response to input drive signals,
wherein the second driver is supported by the first driver such that the second moveable membrane is located behind the first moveable membrane; and
wherein the resilient surround sits behind the first moveable membrane extending from the rim of the frame to the outer part of the first moveable membrane so that the surround does not present an obstacle to sound waves generated by the second driver.

2. A coaxial loudspeaker according to claim 1, wherein the second driver comprises a horn to guide the sound waves generated by the second driver towards a space in front of the first moveable membrane, and wherein the profile of the horn matches a profile of the first moveable membrane.

3. A coaxial loudspeaker according to claim 1, wherein the resilient surround extends from a first edge thereof that is fixed to the rim of the frame to a second edge thereof that is fixed to the outer part of the first moveable membrane.

4. A coaxial loudspeaker according to claim 1, wherein the resilient surround comprises one or more rolls that extend between the rim of the frame and the outer part of the first moveable membrane.

5. A coaxial loudspeaker according to claim 1, wherein the resilient surround extends in a direction that is inclined outwardly away from the central axis from the rim of the frame to the outer part of the first moveable membrane.

6. A coaxial loudspeaker according to claim 1, wherein the resilient surround extends in a direction that is substantially parallel to the central axis of the loudspeaker.

7. A coaxial loudspeaker according to claim 1, wherein the resilient surround further comprises one or more air permeable walls that extend between the rim of the frame and the outer part of the first moveable membrane.

8. A coaxial loudspeaker according to claim 1, further comprising a motor assembly that is coupled to the frame and to the first moveable membrane such that in response to said input drive signals, the motor assembly causes the first moveable membrane to move relative to said frame.

9. A coaxial loudspeaker according to claim 1, wherein the first moveable membrane has a circular, elliptical or oval shaped outer part.

10. A coaxial loudspeaker according to claim 1, wherein the first frequency band lies within a frequency range below 3000 Hz and wherein the second frequency band lies within a frequency range above 2000 Hz.

11. A coaxial loudspeaker according to claim 1, wherein the surround has an annular shape about said central axis and comprises a wall that extends in a direction that is substantially parallel with the central axis or that extends in an outward direction extending away from the central axis.

12. A method of making a coaxial loudspeaker comprising:
providing a first driver for producing sound within a first frequency band;
providing a second driver for producing sound within a second frequency band that includes frequencies that are higher than said first frequency band;
providing a frame;
coupling a first moveable membrane of the first driver to the frame so that the first moveable membrane can move relative to the frame to generate sound waves within said first frequency band in response to input drive signals,
arranging the first moveable membrane to extend from an inner part adjacent a central axis of the loudspeaker to an outer part located above and spaced apart from a rim of the frame,
mounting the second driver on the first driver so that the second driver is coaxial with the first driver and so that a second moveable membrane of the second driver is behind the first moveable membrane of the first driver;
coupling the outer part of the first moveable membrane to the rim of the frame by a resilient surround so that the resilient surround sits behind the first moveable membrane and does not present an obstacle to sound waves generated by the second driver.
